(19) United States
(12) Patent Application Publication
(10) Pub. No.: US 2002/0134896 A1
(43) Pub. Date: Sep. 26, 2002

(54) Strap mounted arm support

(76) Inventor: Ryan T. Hunter, Gaithersburg, MD (US)

Correspondence Address: RYAN T. HUNTER, 10613 WAYRIDGE DRIVE, GAITHERSBURG, MD, 20886, US

(21) Appl. No.: 10/094,751

(22) Filed: Mar. 11, 2002

Related U.S. Application Data
(60) Provisional application No. 60/277,774, filed on Mar. 22, 2001.

(51) Int. Cl. B43L 15/00; B68G 5/00

(52) U.S. Cl. 248/118; 248/118.3; 224/661; 224/908

(57) ABSTRACT

An arm support device for steadying the wearer's weight bearing arm and transferring weight from the arm to the torso. The device is useful over a range of activities which require supporting an implement with one arm, including but not limited to videography, hunting, marksmanship, or fishing. The device comprises a shoulder strap with a cushion mounted thereon. The strap is looped over the head of the wearer and rests on the shoulder opposite the weight bearing arm. The adjustable strap crosses over the front of the wearer's body, under the weight bearing arm, and across the back of the wearer, returning to the shoulder. The strap thereby forms a continuous loop diagonally around the torso of the wearer. The cushion is slidably mounted to the strap, and in use, is positioned between the weight bearing arm and torso. In this manner, the weight is transferred from the arm inwardly to the torso and downwardly to the opposite shoulder. The support device enables the wearer to steady the implement in hand, and counters the onset of fatigue.

### BACKGROUND OF THE INVENTION

1. Field of the Invention

The present invention relates to arm support devices. Specifically, it relates to a cushion mounted on a shoulder strap for steadying the wearer's arm while transferring the weight of an implement from the back and arm to the torso.

2. Description of the Background

Many activities require supporting and/or steadying an implement with one arm. Videography, fishing, marksmanship, and hunting are common examples of such activities. A videographer is required to rest a bulky camera (established weight 25-20 pounds) on one shoulder and support the camera from below with his arm and back. A marksman needs to steady and support a rifle to ensure accuracy. A fisherman is tasked with holding a fishing rod, while a hunter must support a rifle or shotgun. In each case, the back and arm will experience fatigue from supporting the implement; and is unable to properly steady or support the implement. As a result, performance deteriorates. Fatigue is especially problematic where steadying the implement is critical to achieving a successful result, as in camera work (minimize shaky video or film) or marksmanship(increase in accuracy). In the event that the fatigue becomes too great, the activity must cease altogether or injury to back or arm over time may occur.

Inventors have created numerous arm support devices. U.S. Pat. No. 4,083,480 to Lee et al. teaches a stabilizing apparatus for body carried equipment. The apparatus comprises a shoulder mount, a waist belt and a panning arm. Unfortunately, the apparatus is unduly cumbersome as the fully assembled device requires numerous parts that are heavy and increases the amount of hardware that an operator must lug around. The device is impractical for field work because there is additional set-up time required to assemble the device for use and time is a major factor when in the field.

U.S. Pat. No. 5,111,983 to Simmons et al. teaches a camera stabilizing device for supporting the arm of a camera operator. The device comprises a U-shaped member for supporting the arm and a curved support which rests against the thigh. The device is secured to the body with an adjustable strap. Unfortunately, the device uncomfortably transfers the weight of the camera to a single point on the thigh in a manner that localizes the pressure and subjects the area to chafing and fatigue. Moreover, the device is rendered unduly burdensome and limiting because of the numerous components which comprise the device in the assembled and operable configuration.

U.S. Pat. No. 5,528,846 to Baggett teaches an apparatus for helping to hold a device, such as a firearm, steady while aiming at a target. The invention comprises a base attached to the body via a waist-belt, and a rod which extends from the base to the firearm. Unfortunately, the device is made of multiple components and requires attachment both to the belt and the firearm and is thus unduly burdensome to use.

U.S. Pat. No. 5,351,867 to Vest discloses a device to steady the arm of a person holding a bulky article such as a camera. The device comprises a telescoping brace arm which attaches to the belt of the user. One problem encountered with the device is that it offers no support for the arm holding the bulky article. Consequently, although the brace successfully transfers weight to the hip region of the wearer, the cameraman still must extend his arm in an unsupported position away from his torso to operate the camera. That causes limited mobility and maneuverability.

U.S. Pat. No. 4,844,390 to Duke shows a portable arm rest for hunters. The device attaches to the hunter's belt, and comprises an arm pad portion which projects upward to support the extended arm of the hunter. Unfortunately, the utility of the device is limited only to hunters or marksmen as the extended arm support is not adapted to hold the arm in a bent position as when supporting a camera or fishing pole. The device also requires a long set-up time and is cumbersome and awkward to carry in the field.

Lacking in the prior art, is a compact, non-cumbersome, practical arm support device to steady the wearer's arm and retard the onset of back and arm fatigue encountered when supporting a heavy or bulky implement with one arm. Also absent from the prior art is an arm support device comprising a single component which is lightweight, portable, and resistant to damage. The user-friendly arm support device allows for maneuverability while in use but does not interfere with the free movement of the wearer's arm when not in use. Finally, lacking from the prior art is a multi-purpose arm support device adaptable for use over a range of activities.

In light of the foregoing, it would be of great advantage to create an improved arm support device comprising a shoulder strap having an adjustable and releasable support cushion. The cushion rests against the wearer's torso beneath the arm supporting a load, thereby transferring weight from the arm and back to the torso. It would further be of great advantage to create a one-piece, lightweight, portable, shoulder-mounted arm support to steady the implement being used, increasing accuracy while transferring weight from the load bearing arm and back to the torso.

### SUMMARY OF THE INVENTION

It is therefore, an object of the present invention to support an implement while relieving stress from the arm and back of an individual carrying an implement by providing a device comprising a shoulder strap and a support cushion.

It is another object of the present invention to steady an implement by positioning a cushion mounted on a shoulder strap between the extended load bearing arm and the torso.

It is a further object to retard the onset of fatigue encountered when supporting an implement with one arm for an extended period of time by providing a cushioned support for the arm.

It is yet another object to transfer and relieve the weight of an implement carried by an individual from the arm and back to the torso to relieve stress placed on the body.

A still further object of the invention is to provide an arm support comprising a single component to facilitate convenience of use and ease of transport.

It is yet a further object of the present invention to provide an arm support device of a generalized design adaptable for use over a range of activities.

According to the present invention, the above-described and other objects are accomplished by providing an arm support device comprising a shoulder strap and a support cushion. The strap loops over the head of the wearer, under the arm supporting the implement, and the cushion is positioned between the individual's arm and torso. The strap is equipped with an adjustable means to ensure proper fitting and operation. The supporting cushion is freely manipulated along the strap to ensure proper placement of cushion maximizing stabilization and support. In use, the cushion steadies the implement and transfers the weight of the implement from the arm and back to the torso to counter fatigue and enhance comfort.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective view of the arm support device shown apart from the body.

FIG. 2 is an exploded view of the cushion of the arm support device showing the individual body panels and the internal elements.

FIG. 3 is a side elevation view showing the arm support device in an exemplary use by a cameraman.

### DETAILED DESCRIPTION OF THE PREFERRED EMBODIMENTS

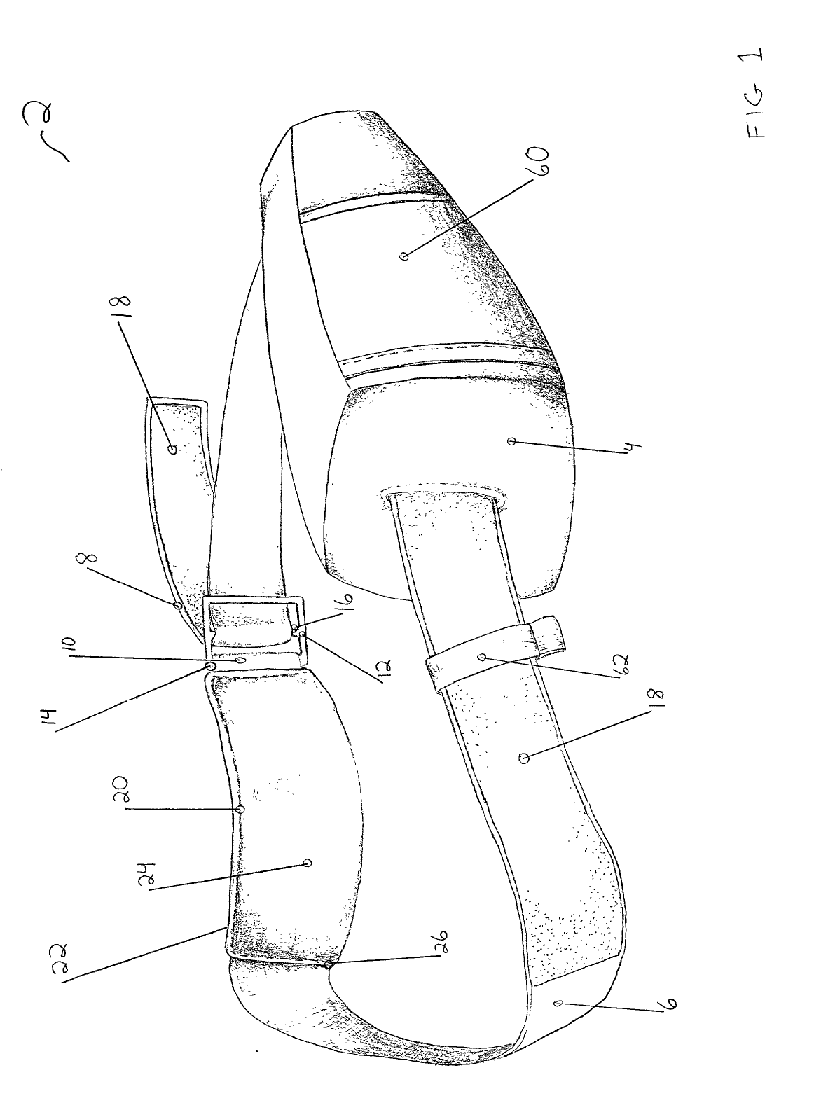

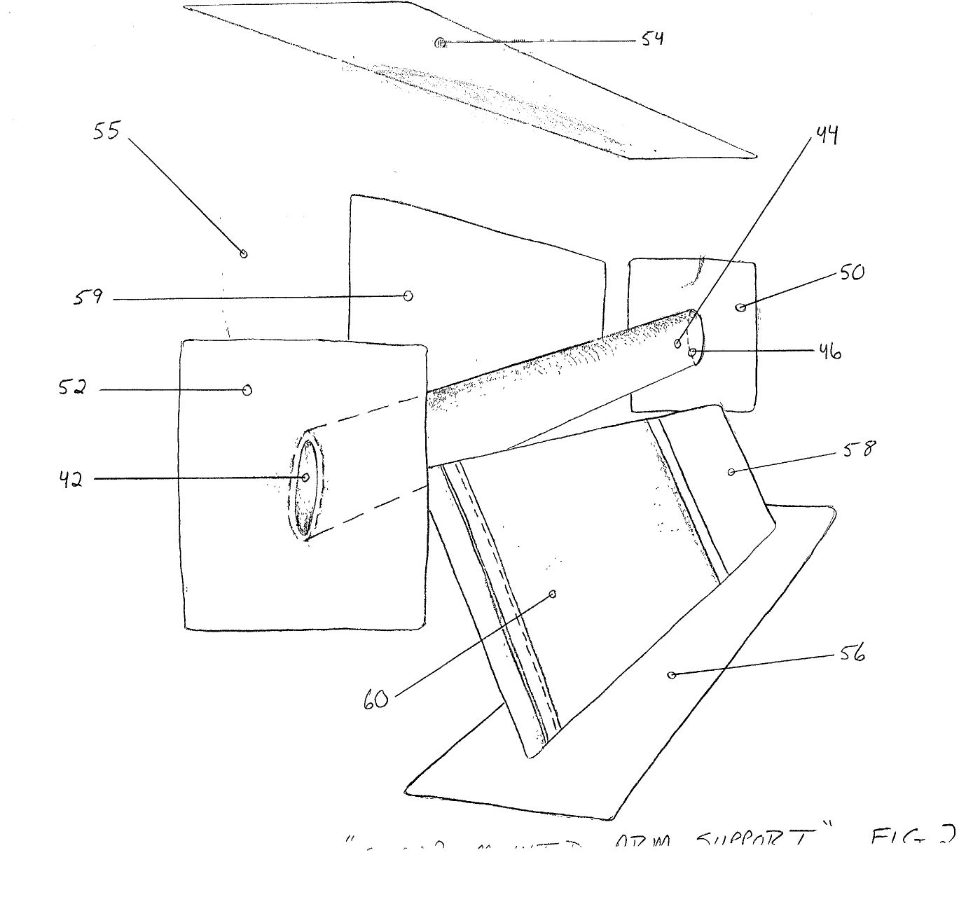

FIG. 1 shows an improved arm support device 2 according to the present invention. A cushion 4 is integrally mounted on strap 6. Cushion 4 comprises six panels of material stitched together as described more fully below with reference to FIG. 2. Strap 6 comprises a woven fabric material having opposing ends 8, 10. Strap ends 8, 10 engage fastener 12, a standard fastener used for attaching the ends of a single length of strap to form a closed loop, and to facilitate adjustment of the strap. Fastener 12 comprises a buckle with four sides having a width approximately equal to the width of strap 6, and length of approximately two inches. Central bar 16 spans the width of fastener 12 at its mid-point.

End 10 engages fastener 12 on one side and forms terminal loop 14 as it passes over the side of fastener 12 and folds back on itself. End 10 is permanently attached to the rear face of strap 6 preferably by stitching.

End 8 is releasably secured to fastener 12 in the following manner: End 8 passes around central bar 16 thereafter folding over itself and running parallel to strap 6. The underside of end 8, plus the facing side of strap 6 carries corresponding elements of hook and pile fastener 18. Accordingly, end 8 securely attaches to strap 6 along the stretch of hook and pile fastener 18 to secure the device when in use. End 8 is released from strap 6 to adjust the strap or to simplify taking-off the device.

As shown in FIG. 1, a shoulder pad 20 and cushion 4 are integrally attached to strap 6 between ends 8, 10. Shoulder pad 20 comprises an elongated pad having upper strip 22 and a lower strip 24. Upper strip 22 is a soft, supple material, preferably leather, which provides a durable yet comfortable shoulder rest. Lower strap 24 comprises a suede material or other grip enhancing material which prevents the shoulder pad from sliding off the shoulder. Upper strip 22 and lower strip 24 are stitched together lengthwise along their margins. So attached, upper strip 22 and lower strip 24 comprise shoulder pad 20 having central sleeve 26. Strap 6 engages pad 20 by passing through central sleeve 26. Pad 20 is thereby slidably attached to strap 6. Alternatively, pad 20 is cross-stitched to strap 6. Cross-stitching renders pad 20 fixedly engaged to strap 6 and prevents sliding along strap 6.

Cushion 4 is an essential element of arm support device 2. FIG. 1 shows cushion 4 mounted on strap 6. Strap 6 engages cushion 4 by entering opening 42, passing through central sleeve 44 (as shown in FIG. 2), and exiting via opening 46. So mounted, cushion 4 slides along strap 6 in a manner that facilitates adjustment in use. Further, when device is not positioned for use on user, cushion 4 may be used to steady and support a camera or rifle on a surface, or provide a backrest, knee rest, or headrest.

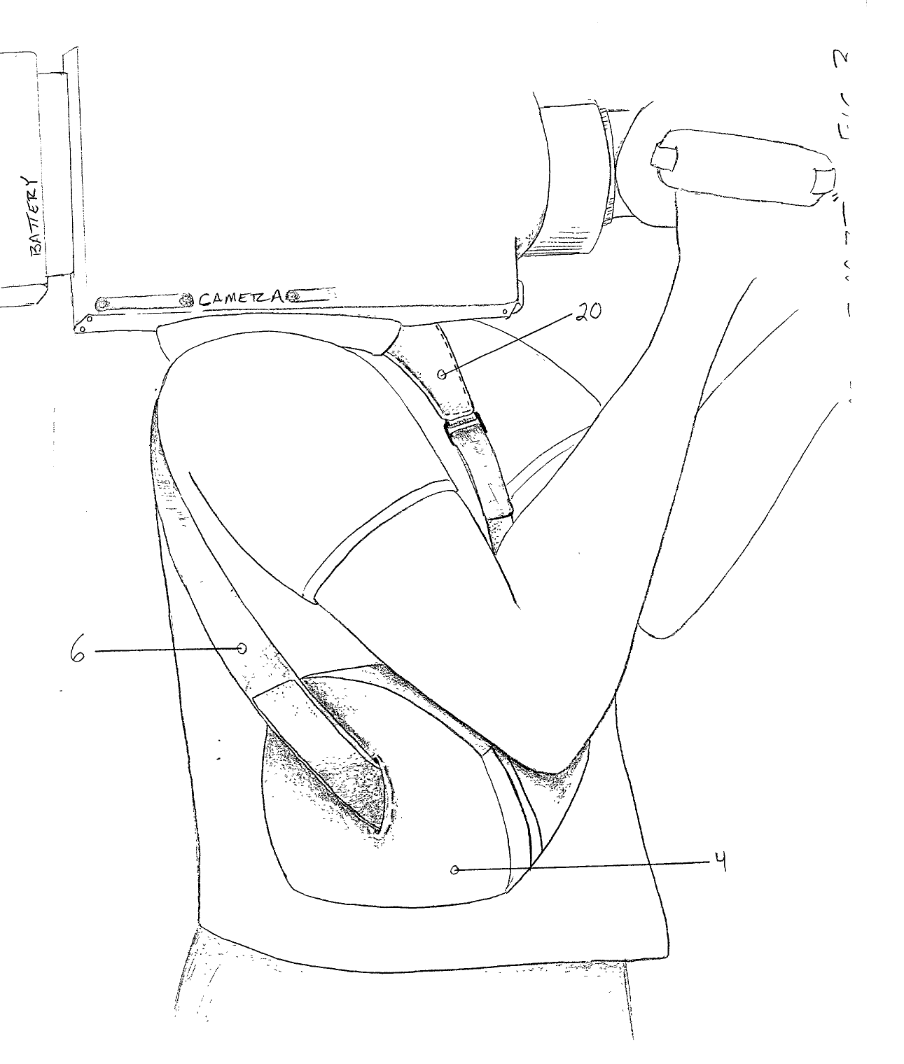

FIG. 2 is an exploded view showing the components of cushion 4. Cushion 4 comprises six exterior panels including end panels 50, 52, top panel 54, bottom panel 56, and side panels 58, 59. The panels are of a durable material such as leather, woven fabric, canvas, vinyl, or the like. The panels are assembled as shown in FIG. 3 by joining top 54, bottom 56, and side 58, 59 panels in a generally boxlike configuration. End panels 50, 52 are attached to seal the ends of cushion 4. All panels are stitched at their seams to form assembled cushion 4. Optional pouches or pockets 60 (as shown in FIG. 1) may be attached to one or more of the panels to provide storage space for accessories such as video tape, wireless AV microphones, sunglasses, or ammunition.

Referring again to FIG. 1, a plurality of attachments 62 may be fixed to strap 6 to facilitate the attachment of accessory bags, panniers, or attachments such as cables, fishing line, and lures.

Cushion 4 preferably comprises a tapered shape. In this regard, end panel 52 is cut larger than end panel 50, and the margins of panels 54, 56, 58, and 59 are correspondingly larger where they meet end panel 52 than the opposite margins which attach to end panel 50 (See FIG. 2). Additionally, the width of side panels 58, 59 is greater than top and bottom panels 54, 56. As a result, end panels 50, 52 comprise rectangular shapes with their longer sides corresponding to side panels 58, 59 and their shorter sides corresponding to top and bottom panels 54, 56.

Central sleeve 44 passes through the interior of cushion 4 and forms a channel through which strap 6 passes to engage cushion 4. Sleeve 44 is accessible through opening 42 on end 52 and opening 46 on end panel 50. Stuffing material 55 surrounds sleeve 44 and lies inside of the panels giving shape and body to cushion 4. Stuffing material 55 is preferably of a pliant cotton foam, or granular “bean-bag” composition, making cushion 4 firm yet comfortable and able to minimize body motion which would otherwise be transmitted to the device being carried.

### In the Operation

FIG. 3 shows an elevation view of arm support device 2 in an exemplary use by a camera operator. The camera rests on the operator's shoulder and is supported from beneath by the operator's back and arm. The operator shown in FIG. 3 is a right-handed operator, but it should be noted that the arm support device 2 is equally adaptable for use by a left-handed operator by reversing the orientation of cushion 4 on strap 6. Shoulder strap 6 loops over the head of the cameraman and rests on the shoulder opposite the camera. Strap 6 crosses diagonally over the front of the operator's body, and under the arm supporting the camera. Cushion 4 is positioned between the operator's arm and torso. Strap 6 extends from cushion 4 across the back of the operator to its beginning point on the operator's shoulder.

So assembled, cushion 4 supports the operator's weight bearing arm, transferring the camera weight from the back and arm to the operator's torso. The bulkier end of cushion 4 corresponding to end panel 52 is directed to the outside of the wearer's body and receives the brunt of the force from the wearer's elbow. The narrower end of cushion 4 corresponding to end panel 50 is directed to the inside of the wearer's body. The greater depth provided by side panel 58 lying against the wearer's arm, and side panel 59 lying against the wearer's torso stabilizes cushion 4 and inhibits undesirable rolling of cushion 4 under the arm. Panel 52 is larger than panel 50, countering the shape of the torso, resulting in a parallel support system. The weight is further directed along strap 6 to the operator's shoulder from which the upper back muscles are drawn upon for additional support. In this manner, the operator effectively spreads the weight of the camera from the arm to a larger group of muscles in the upper body. Further, support device 2 steadies the operator's arm and counters fatigue. When used by a cameraman, the steadied camera arm minimizes shake in the picture, an improvement most notably evident at longer zoom angles. Moreover, the pliant stuffing material 55 absorbs small body movements and vibrations.

The generalized nature of arm support device 2 as assembled and used as described herein avails the device to a range of applications where arm support is required. Accordingly, the device may find favor with fishermen who suffer fatigue from holding a fishing rod away from the body with one arm over an extended period of time. Used essentially as described above, arm support device 2 is slung over the head of the fisherman and cushion 4 is tucked under the arm holding the rod. So positioned, cushion 4 provides a support between the fisherman's arm and torso, thereby alleviating fatigue by re-distributing the weight of the rod over the upper body.

Arm support device 2 is likewise used by hunters to support a firearm. For a right-handed hunter using a shotgun or rifle, the trigger is held in the right hand, and the barrel of the firearm is held by the opposite hand. Accordingly, the left arm is raised and extends away from the body. To support the raised left arm, the hunter dons arm support device 2, shortens strap 6, and slides cushion 4 under the extended left arm. In this application, arm support device 2, counters fatigue and improves the hunter's accuracy by steadying the firearm both while aiming at a target and after the firearm is discharged.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims:

I claim:

1. An arm support operative to transfer the weight of an object from a weight bearing arm inwardly to the wearer's torso and opposite shoulder, increasing accuracy and stability, comprising:
(a) a shoulder strap;
(b) a cushion releasably mounted to said strap,
whereby said shoulder strap is looped over the head of said wearer, and engages said wearer's shoulder opposite said weight bearing arm and crosses under said wearer's weight bearing arm, said cushion being positioned between said wearer's torso and weight bearing arm.

2. The shoulder strap of claim 1, wherein said strap comprises a padded shoulder strap.

3. The cushion of claim 1, wherein said cushion comprises top, bottom, side, and end panels stitched together along their margins in a box like configuration; said panels defining the outer surface of said cushion; and is adjustable along strap.

4. The end panels of claim 3, wherein said end panels comprise openings which access a central sleeve traversing the inside of said cushion between said end panels.

5. The shoulder strap of claim 1, wherein said strap comprises a fastener comprising a rectangular configuration and a centrally disposed bar running parallel to one pair of sides and attached at each end perpendicularly to the other sides, said fastener engaging the ends of said strap; allowing strap to adjust to different sizes.

6. The shoulder strap of claim 1, wherein said strap comprises a first end which forms a permanently closed terminal loop about said fastener, and a second end which forms a terminal loop about said fastener having an operable engagement means.

7. The shoulder strap of claim 6, wherein said operable engagement means in a hook and pile fastener.

8. The shoulder strap of claim 1, wherein said strap comprises a plurality of attachments.
